(19) United States
(12) Patent Application Publication
(10) Pub. No.: US 2024/0300732 A1
(43) Pub. Date: Sep. 12, 2024

(54) CARTRIDGE, ASSEMBLY AND CUP FOR PREPARING LOOSE LEAF TEA AND METHOD OF PREPARING TEA

(71) Applicant: T-CAP IP B.V., Amsterdam (NL)

(72) Inventors: Hakan Duman, Amsterdam (NL); Jonattan Asmerson, Amsterdam (NL); Melanie Reep, Amsterdam (NL)

(21) Appl. No.: 18/272,785

(22) PCT Filed: Jan. 12, 2022
(86) PCT No.: PCT/NL2022/050005

§ 371 Date: Jul. 17, 2023

(30) Foreign Application Priority Data
Jan. 27, 2021 (NL) 2027442

(51) Int. Cl. B65D 85/812; A23F 3/18; A47G 19/16; A47J 31/06; A47J 31/20

(52) U.S. Cl. CPC B65D 85/812; A23F 3/18; A47G 19/16; A47J 31/0636; A47J 31/0642; A47J 31/20

(57) ABSTRACT

A cartridge for preparing a flavoured drink comprises an infusion chamber for containing flavouring materials and infusing a liquid with flavouring substances. A passage in the chamber wall allows liquid exchange between the infusion chamber and its exterior. A flow drive system drives a liquid flow between the infusion chamber and its exterior through the passage in a flow direction which projects from the chamber wall. The cartridge may have an outer wall which is movable to cover and close the passage. A manual control may be used to open or close the passage. The manual control may have a cover covering a top-side of the chamber wall and interlocking with the chamber wall. The cover may include a cup-shaped grip partitioned in first and second upwards open parts, for admitting respective finger(s) of the user. A partitioning wall may separate the parts and allow exertion of a rotational force.

### FIELD

The invention relates to cartridges, assemblies and cups for preparing tea or other flavoured drinks and methods of preparing tea or other flavoured drinks, such as from loose tea leaves or from other solid or liquid flavouring materials which release flavouring substances in a liquid suitable to be consumed, e.g. by a human being. In particular, but not exclusively, the invention relates to preparing hot or cold beverages in-situ in a cup.

### Background

Solutions for preparation of hot or cold beverages in-situ in a cup are known, as well as the preparation of hot or cold beverages prior to pouring in a cup. For example, preparing tea with a French-press is disclosed in United States patent application publication number US2012-0216682. In this solution, the brewing process can be stopped by pressing a plunger downwards to form a closed-off chamber with the loose tea leaves.

International patent application publication WO2018194450A1 discloses a cartridge for controlled brewing of loose-leaf tea in a cup. The cartridge comprises an infusion chamber for containing loose tea leaves and infusing a liquid with substances from the tea leaves to brew tea. A chamber wall impervious to the liquid defines the infusion chamber. In the chamber wall is a passage between the infusion chamber and an exterior thereof. The passage has an open state in which the infusion chamber is in liquid communication with the exterior, to transport the substances from the infusion chamber into liquid in the exterior during brewing tea. In a closed state the infusion chamber inside is closed off from liquid in the exterior to stop a concentration of the substances in the liquid in the exterior from increasing. A manual control manually controllable by a human-being allows to bring the passage from the open state into the closed state.

The cartridge disclosed in this prior art document allows to control the strength of the tea or other flavorized drinks by manually controlling the state of the passage and works satisfactory in that respect. However, it is desirable to more precisely control the brewing.

### SUMMARY

The present invention provides cartridges, assemblies and cups for preparing a flavoured drink, as well as methods of preparing a flavoured drink, as described in the accompanying claims.

Specific embodiments are set forth in the dependent claims.

These and other aspects will be apparent from and elucidated with reference to the embodiments described hereinafter.

### BRIEF DESCRIPTION OF THE DRAWINGS

Further details, aspects and embodiments will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a sectional view of a prior art cartridge, illustrating the liquid flow therein.

FIG. 2 schematically shows a cross-sectional view of a first example of a cartridge placed on a cup.

FIG. 3 schematically shows an exploded perspective view of a second example of a cartridge.

FIG. 4 schematically shows a sectional, exploded view of the example of FIG. 3.

FIG. 5 shows a perspective, sectional view of a housing part suitable for the example of FIG. 3

FIG. 6 shows a perspective, sectional view of the housing part of FIG. 5 with a chamber wall therein.

FIG. 7 shows a perspective view of the example of FIG. 3 with the infusion chamber opened at a top-side thereof.

FIG. 8 shows a side view of an example of a cover suitable for closing off the top-side of the example of FIG. 7.

FIG. 9 shows a side view of the example of FIG. 8 during manual control thereof by a user.

FIG. 10 shows a perspective view of the example of FIG. 3 in an open state, during manual control of the state of the cartridge.

FIG. 11 shows a perspective view of the example of FIG. 3 during a transition from the open state to a closed state.

FIG. 12 shows a cross-sectional view of a bottom part of a third example of a cartridge in the open state.

FIG. 13 shows a cross-sectional view of the bottom part of the example of FIG. 12 in the close state.

FIG. 14 shows a cross-sectional view of the example of FIG. 3 in an assembled state, with the infusion chamber opened at the top-side

FIG. 15 is a bottom view of the outer wall of the example of FIG. 14

FIG. 16 is a bottom view of the chamber wall of the example of FIG. 14.

FIG. 17 is a perspective view of the bottom side of the example of FIG. 14.

### DETAILED DESCRIPTION OF THE PREFERRED EMBODIMENTS

In the following, details will not be explained in any greater extent than that considered necessary for the understanding and appreciation of the underlying concepts of the present invention and in order not to obfuscate or distract from the teachings herein.

In the examples, the brewing of a flavoured drink can be controlled more accurately because the cartridge has the features of one, more than one, or all of the aspects described below. These aspects allow to more precisely control the spreading of the flavouring substances into the liquid outside the cartridge and to have a sharper transition between a flavouring phase and a non-flavouring phase. In case the cartridge is of a type that can be closed to stop, and optionally also be opened to (re-)start, the brewing, the brewing can be controlled to behave more closely as an ideal side step-function, i.e. either the liquid in the exterior is being infused with the flavouring substances or is not being infused at all.

In a first aspect, the cartridge may comprise a flow drive system which drives, when the system is in operation, a liquid flow between the infusion chamber and the exterior of the chamber through the passage, the liquid flow having in at least a part of the infusion chamber a flow direction which projects from the chamber wall. This allows to not only disperse the infused liquid faster in the exterior but also accelerates the extraction of the flavouring substances.

In addition, the gradient in concentration of the flavouring substances between the infusion chamber and the exterior thereof during brewing can be reduced. This not only allows to reduce the time required to flavour the liquid in e.g. a cup, tea-pot or other liquid containing vessel, it also allows to reduce the time lag between substances being released in the infusion chamber and thus the infused liquid spreading throughout the vessel. Accordingly, it is made easier for the user to estimate the time needed to arrive at a degree of flavouring satisfying the taste of the intended consumer of the beverage. Furthermore, this allows to have an infusion rate which is more constant over time, and accordingly a more predictable behaviour which allows a user to better estimate of the time needed to obtain a flavouring satisfying the taste of the user.

In a second aspect, the infusion chamber can be opened and closed by means of an outer wall which covers a part of the outer surface of the chamber wall and which is movable relative to the chamber wall to cover and close the opening in the chamber wall. In this second aspect, upon moving the outer wall, the outer surface is pressed onto the outer wall to seal-off the opening. This allows to better stop the infusion, because liquid and flavouring substances are, at least partially, inhibited or completely blocked, from seeping in the closed state between the chamber wall and the outer wall. Thus, in the closed state the gradient in concentration of the flavouring substances between the infusion chamber and the exterior thereof can be increased, and accordingly even though in the infusion chamber brewing may continue, this will not affect the concentration outside in the exterior and hence the drink remains according to the user's taste for a longer period of time after closing the infusion chamber.

In a third aspect, the cartridge may comprise a manual control for manually exerting by the user a force on the cartridge to open or close the opening. With the third aspect, a sharper, and faster, transition to the closed state can be obtained. The manual control comprises a cover for covering a top-side of the chamber wall, the cover interlocking with the chamber wall. The cover comprises a cup-shaped grip which is partitioned in a first upwards open part for admitting at least one finger of the user and a second upwards open part for admitting at least one other finger of the user. A partitioning wall with sidewalls for manually exerting with the fingers a rotational force, separates the upwards open parts and extends from a peripheral edge of the grip inwards, e.g. towards the opposite side of the edge, such as radially through the centre. By squeezing with fingers on the partitioning wall, the edge can be deformed to release the interlocking. Due to the partitioning wall, a user can more quickly rotate the control and hence close the passage faster. Thus, the transition between open and closed state can be more pronounced. In addition, due to the squeezing, the cover can be removed and put in place faster. Thereby, e.g. after placing the cartridge with the flavouring substances, the manual control is earlier ready for use, and hence control of the process available more quickly.

The cartridge as used herein may be a prefabricated receptacle that can be easily inserted in, and attached to, a vessel with a liquid serving as the base of the beverage to be prepared. In the receptacle e.g. loose tea leaves or other flavouring substances can be provided to be controllable released into the liquid, e.g. by extraction or solution. The cartridge may be such that it can be closed-off to keep the flavouring substances into the receptacle, at least until the consumer releases them into the liquid. The vessel can e.g. be a pot, bowl or cup, and for instance be a drinking cup from which a human consumer will drink the beverage, and which allows a controllable release of flavouring substances into a consumable liquid in the cup, controlled by the consumer. The cartridge may for example be conceived for preparing a flavoured drink in-situ in a cup.

The cartridge may be permanently or releasably attachable to the cup, e.g. by laterally moving the cartridge into the cup without rotation. For example, the cartridge may be pressed on the rim of the cup to lock an interlocking mechanism. In case of a releasable attachment, the cartridge may be replaced with another interchangeable cartridge, for instance in case of a non-disposable cup.

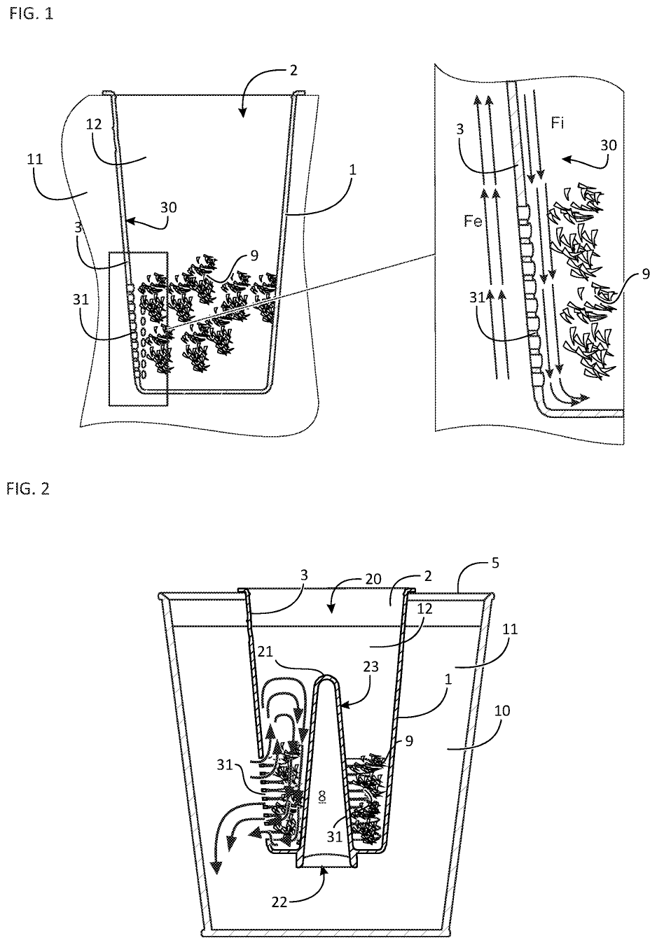

Referring to FIG. 1, a cartridge 1 according to the prior art is shown therein, as is known for brewing tea in tea pots. As shown, the cartridge 1 comprises an infusion chamber 2 which is delimited by a chamber wall 3 with passages 31 therein. The passages 31 provide a passage through the chamber wall via which liquid can be exchanged between the infusion chamber 2 and the exterior of the chamber. In the infusion chamber 2 loose tea leaves 9 are present which release, e.g. by extraction or solution, flavouring substances in the liquid 12 in the infusion chamber 2. Via the passages 31 the flavouring substances spread into the liquid 11 in the exterior.

However, in this prior art cartridge the spreading takes a relatively long time. Without wishing to be bound to theory, this is believed to be caused by the diffusive nature of the infusion process and the spreading thereof into the exterior. Again without wishing to be bound to theory, this is believed to be caused as follows. Firstly, in this prior art, as illustrated with the arrows Fi at the righthand side of FIG. 1, in the region inside the infusion chamber adjacent to the inside surface 30 of the chamber wall 3 the liquid 12 in the infusion chamber 2 flows parallel to the inside surface 30. The tea leaves are mainly outside that area and thus not subject to an extracting liquid flow. Similarly as illustrated with the arrows Fe, in the exterior, the liquid 11 flows in the region adjacent to the chamber wall 3 parallel to the exterior surface 33. As a consequence, during brewing the exchange of liquid between the infusion chamber and the exterior is limited.

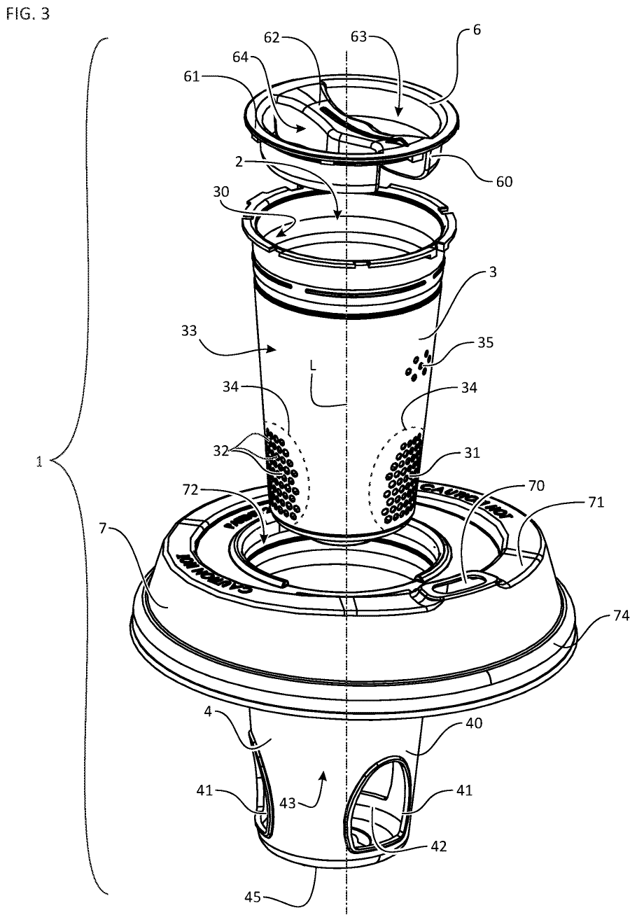

Referring to FIG. 2, an example of a cartridge 1 for brewing of a beverage, such as loose-leaf tea, in a cup is shown therein. In this example, the cartridge 1 consists of a single, integral part but as shown in FIGS. 3-4 for example, the cartridge 1 may consists of two or more separate parts assembled, e.g. by interlocking engagements, into a cartridge. As shown, the cartridge 1 may comprise an infusion chamber 2 for containing tea leaves 9 and for infusing the portion 12 of the liquid 10 inside the infusion chamber 2 with flavouring substances released by the tea leaves 9. The infusion chamber 2 is defined by a chamber wall 3. In this example the chamber wall is impervious to the liquid 10, but the chamber wall alternatively be pervious e.g. to water. In the chamber wall 3, a passage 31 is provided between the infusion chamber 2 and an exterior thereof, i.e. the rest of the cup 5 when placed thereon. The infusion chamber 2 can be open at the top-side, and the chamber wall 3 can be a frusto-conical shape which extends from the top-side and has a flat bottom. Other shapes are possible as well, and for example the bottom may be shaped as a spherical cap, the chamber wall may have another tapered or not tapered shape, such as a frusto-pyramid or otherwise. Preferably, the chamber wall has a shape without overhangs, which allows moulding thereof in a single shot . . .

The cartridge 1 can be used to prepare tea (or other hot drinks or cold drinks-like citronade or mint water). As shown, the cartridge 1 can be placed into a vessel 5 which is filled with a liquid 10. In case the vessel 5 is a cup, the volume may e.g. be less than 1 l and more than 1 dl, such as a volume in the range between 1 dl and 6 dl, for example between 2 dl and 4 dl, for example. More specifically the cartridge 1 can be placed suspended in the bowl-shaped part of the vessel 5 hanging from, and being supported by, a top rim of the vessel 5 or e.g. be placed on and supported by the bottom of the bowl-shaped part.

As illustrated in FIG. 2, in such a method the cartridge is placed in the vessel 5 and the vessel 5 is filled, prior to or after placing the cartridge, at least partially with a liquid 10, e.g. one suitable to prepare tea, e.g. hot water, milk, lemon juice or other suitable (mixture of) liquid(s), and optionally flavourings like sugar, sliced lemon etc. The liquid may be cold, e.g. with a temperature below 25° C., or warm, e.g. with a temperature above 25° C. and below 65° C. The liquid may for example be a hot liquid and have a temperature equal to or above 65° C., e.g. equal to or above 75° C. and less than boiling temperature, such as at or below 95° C., e.g. at or below 90° C., for example at or below 80° C.

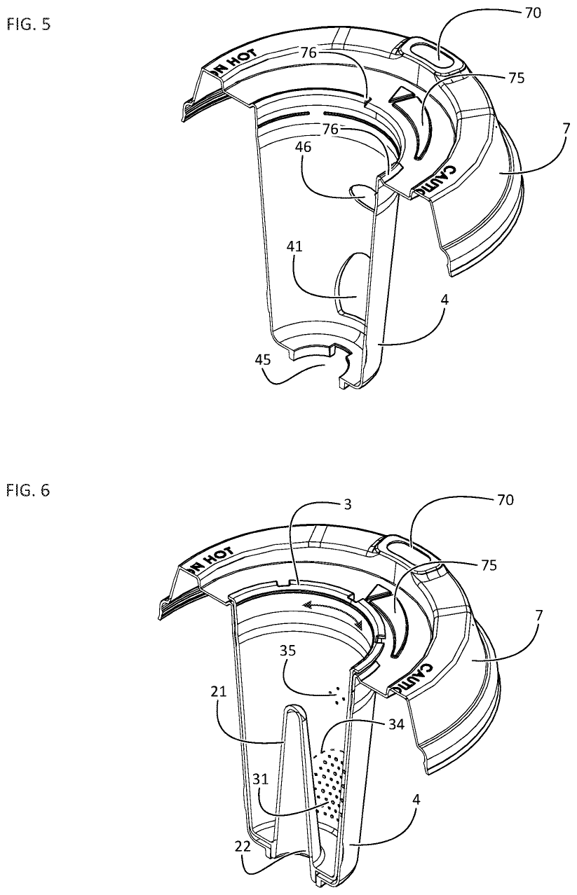

The cartridge 1 may be made of a material which withstands such hot liquid. As best seen in FIG. 7, the cartridge may be provided with a warning “caution hot” to signal to the user that the liquid is above skin-burning temperature, e.g. the temperature at which skin burns in a couple of seconds, such as in about 1 second (in which case the temperature would be above 70° C.). The cartridge may e.g. be a disposable cartridge such as made of (coated) paper or a suitable (thermo-) plastic as commonly known for disposable cups. Also, the disposable cartridge may be made of a bio-degradable material. Alternatively, the cartridge 1 can be non-disposable and e.g. be dishwasher proof, and e.g. made of a thermoset plastic, a thermoplastic with a glass transition point above 60° C., glass ceramics or other suitable non-disposable material.

As shown, the cartridge is placed in the vessel 5 such that, in use and when the liquid level in the vessel 5 is at the maximum intended height, the air-liquid interface is above the bottom of the cartridge. The infusion chamber is at least partially or completely filled with the liquid, e.g. flowing in from the exterior part of the vessel via the openings in the chamber wall or being poured from the top-opening into the infusion chamber and then filling via the openings the exterior part of the vessel 5.

When the flavouring materials 9, in this example the tea leaves are brought into contact with the liquid 12 in the infusion chamber 2, flavouring substances will be released in the liquid.

In this example, the cartridge 1 is provided with a flow drive system 8. When the flow drive system is in operation, which is during brewing the drink, the flow drive system 8 drives in the infusion chamber 2 a liquid flow through the passage 31 between the infusion 2 chamber and the liquid 11 in the exterior of the chamber. As shown with the arrows, the liquid flow has in at least a part of the infusion chamber 2 a flow direction which projects from the chamber wall. The liquid passes through the tea leaves 9. Thereby, the release rate of the flavouring substances increase. The time needed to brew inside the infusion chamber a drink with a desired strength can thus be reduced. In addition, the release rate may be made more constant over time, and accordingly the preparation be more predictable to a user.

As further illustrated, in addition, the flow driven by the flow drive system passes through the passages 31. This allows to increase the exchange rate of liquid between the infusion chamber 2 and the exterior. Flavouring substances are thus transported faster out of the infusion chamber into the volume of liquid 11 in the part of the vessel 5 outside the infusion chamber 2.

Although the flow drive system may generally drive any flow suitable to accelerate the infusing process, that is accelerated relative to a cartridge where only temperature differences at the wall of the cup and or at the air-liquid interface at the open top drive some liquid flow. In the shown example, for instance, the liquid flow is from the exterior, circulating in the infusion chamber, to the exterior. The liquid flow, in a liquid flow direction, enters the infusion chamber at a position above a position where the liquid flow exits the infusion chamber. The liquid flow comprises, in a flow-direction: an inflow from the liquid 12 in the exterior, through the passage 31, a circulating flow in the infusion chamber 2 which passes through the loose tea leaves 9 containing space of the infusion chamber, and an outflow through the passage from the loose tea leaves 9 containing space into the liquid 12 in the exterior. Although in these examples the flow inside the infusion chamber is in the radial direction, from the chamber wall towards the axial centre or vice versa, as well as the axial direction, in this example downwards, it will be apparent that the flow may additionally have a tangential component.

More specifically, in this example, a heat exchange surface 23 generates a flow in a downwards direction of the liquid in thermal contact with, and flowing over, the surface. At the upper part of the heat exchange surface 23, this downwards flow sucks in liquid from the exterior. The downwards flow is bend towards the exterior by the bottom of the chamber wall 3, which extends transverse to the flow-direction of the downwards flow, in this example, horizontally (when the cup is placed upright).

In the shown example, the passage 31 comprises a region 34 in the chamber wall with at least an upper opening and a lower opening. The liquid flow through the upper opening is into the infusion chamber and the liquid flow through the lower opening is out of the infusion chamber. In this example, this flow is established by cooling at the heat exchange surface 23, thus due to the increase in density creating the downwards flow, which as shown, starts at about the same height at the upper opening, and thus sucks in the liquid from the exterior through the upper opening. As shown, the bottom part of the chamber wall bends the liquid flow to the lower opening to flow out of the infusion chamber. Although in this example, the upper opening and the lower opening are slit-shaped, and the passage 31 comprises a number of vertically distributed slits, the passage 31 may have a different shape. For instance, in the example of FIGS. 3-4, the chamber wall 3 is of a closed material, impervious to the liquid and the passage 31 comprises a perforated region 34 of the chamber wall, with perforations sufficiently small to retain solid particles in the infusion chamber, as is more clearly seen in FIG. 6, for instance.

The perforated regions can retain solid particles with a size above a retaining threshold. In such a case, the solid particles may all be larger than the threshold or alternatively have a size distributed over a range below the threshold, e.g. a (semi-)normal distribution with an average above the threshold and a fraction, e.g. 5% or less below the threshold, for instance. The solid particles may for example consist of a first, coarser fraction with a size larger than the retaining threshold and a second, finer, fraction with a size smaller than the retaining threshold, the first fraction being at least 60% of the total number of solid particles and the second fraction being balancing the total to 100%.

The second fraction can for example consist of broken solid particles and the first fraction of unbroken solid particles or at least broken into coarser particles than the second, finer, fraction. For instance, in case the case of tea leaves the first fraction may comprise or consist of pekoe (mostly unbroken leaves) and/or broken leaves, and the second fraction may comprise or consist of fannings and/or dust.

The flow drive system may be any type of flow drive system suitable for the specific implementation. The flow drive system 8, as in the examples, may be in physical contact with the liquid in the infusion chamber 2, and more specifically directly drive the liquid flow in the infusion chamber. Said differently, the flow drive system 8 may be, at least partially, exposed in the infusion chamber 2 and the exposed parts of the system 8 contact the liquid in the infusion chamber 2 to drive the flow. Alternatively or additionally, the liquid outside the infusion chamber may be driven to flow in such a manner that via the passages the liquid in the infusion chamber is made to flow such that the infusing process in the infusion chamber is accelerated, as well as the transport of the infused liquid, via the passages, to the outside of the infusion chamber.

The flow drive system may e.g. comprise a mechanical pump, such as located in the infusion chamber and/or may comprise (or as in the shown example consist of) a non-mechanical system. In the shown example, the flow drive system is a non-mechanical system, more specifically a thermal convection system and the liquid flow is thermally induced. In this example, the driving force which drives the flow is gravity, but other thermally induced driving forces may be used as well. Although the flow drive system may comprise mechanical, moving, parts, in this example the flow drive system is mechanically static and does not have any moving parts. More specifically, the flow drive system comprises a thermal element located in the infusion chamber which generates a temperature gradient in the liquid 12 in the infusion chamber. Due to the corresponding change in density of the liquid, flow of the liquid 12 in the infusion chamber will occur. In this example the thermal element is a thermal block 21 which comprises a heat reservoir and a heat exchange surface 23 which is exposed in the infusion chamber, for transferring thermal energy from or to the liquid in the infusion chamber and to or from the heat reservoir. In the shown example, only a single thermal block is present but alternatively the infusion chamber 2 may be provided with two or more thermal blocks at different locations. For example, in addition to the shown block, thermal elements at the entrance 20 of the infusion chamber may be provided which create a temperature gradient there as well.

As show, the temperature gradient is generated in the liquid volume, below the air-liquid interface. In this example, assuming that the heat exchange surface 23 has a uniform temperature, the gradient will at the height of the inflow, mainly be in the horizontal direction, and be a fairly sharp transition between a bulk volume of the liquid and a boundary layer along the heat exchange surface, which separates the bulk volume from the heat exchange surface 23. In addition in the direction from the inflow to the outflow, the flow away from the heat exchange surface will have exchanged heat with the surface 23, and thus differ in temperature from the bulk volume.

In case the liquid 10 is above ambient temperature, and used to prepare a hot beverage for example, the heat reservoir can be a heat sink. In such a case thermal energy is transferred from the liquid in the infusion chamber into the heat sink. In the shown example for instance, the heat exchange surface 23 is cooled by the heat sink to a temperature below the temperature of the liquid. For instance, although other ranges may be suitable, the heat exchange surface 23 can be cooled to exhibit a temperature difference with the average, also referred to as bulk, temperature of the liquid 10 in the infusion chamber in the range of between 20° C. and 60° C., for instance a difference of less than 40° C. It is found that already a difference at the lower limit of this range can induce a liquid flow sufficient to noticeably accelerate the brewing time. On the other hand, it is found that a temperature difference below the upper limit of this range can be obtained without active cooling or active transfer of heat out of the chamber-vessel system. In such a case for example, the heat reservoir may prior to brewing have been at ambient temperature, and after the warm or hot liquid is brought into the vessel and the infusion chamber, store the heat received from the heat exchange surface to cool down the liquid in thermal contact with the heat exchange surface to a temperature between that of the hot liquid and the ambient temperature.

Alternatively, the heat reservoir may be a heat source and the heat exchange surface be heated to be above the initial, bulk, temperature of the liquid 10. For example, in case the cartridge 1 is used to prepare a cold beverage the liquid 10 can be a cold liquid with a temperature below ambient temperature, such as with a temperature between 0° C. and 10° C., for example. In such a case for example, the heat reservoir may prior to brewing have stored thermal energy from the ambient temperature and, after the cold liquid is brought into the vessel and the infusion chamber, transfer the stored heat to the heat exchange surface to heat up the liquid in thermal contact with the heat exchange surface to a temperature between that of the cold liquid and the ambient temperature.

The thermal block 21 may have any suitable shape and location. The heat exchange surface 23 can for example project from the chamber wall 30, in FIG. 2 into the infusion chamber 2. Thus, relative to the chamber wall 30, a temperature difference is generated with a corresponding flow of liquid caused by the change in density of the liquid upon exchanging heat with the heat exchange surface 23. In the shown example, the heat exchange surface 23 projects from the bottom of the infusion chamber 2 upwards. Thus, in case the heat exchange surface cools the liquid in thermal contact therewith, assuming for water as the liquid that the temperature is above 4° C., the liquid flow over the heat exchange surface will be downwards. Vice-versa, in case the liquid in thermal contact with the heat exchange surface is heated up, the liquid flow over the heat exchange surface will be upwards.

In the shown example, the heat exchange surface projects from the bottom, and the liquid flow over the heat exchange surface will be upwards in case of heating or downwards in case of cooling. In addition to the liquid flow being higher, this liquid flow direction is opposite to the natural convection direction caused by the typical temperature difference at the exposed liquid surface at the top of the vessel and the cartridge, and between the liquid and the walls of the vessel.

Although the heat reservoir may in general be made of any suitable solid, liquid or gaseous material having a sufficient heat capacity, in the shown example the heat reservoir comprises a volume defined by the heat exchange surface which is filled, or fillable, with a fluid different from the liquid. In this example, the volume can be filled with air and the volume projects into the infusion chamber. More specifically, the volume is a cavity which has an opening 22 to the exterior for trapping air. The cavity is separated and sealed from the infusion chamber by the heat exchange surface 23. In this example, the cavity projects from the bottom of the infusion chamber upwards and forms a hollow space. The opening 22 of the cavity is located at the bottom, and the cavity forms in this example an open-bottomed wet bell in the vessel 5. Prior to use, the hollow space is in communication with the ambient gasses surrounding the cartridge, i.e. in a typical situation air and filled with these gasses. The ambient gasses are at the ambient temperature, e.g. outdoors air at the outdoor temperature, indoors this can be air at room temperature (between 15° C. and 28° C., such as between 18° C. and 24° C., e.g. around 20° C. Depending on the specific type of room and climate this can be in the range of 23° C.-25.5° C. in summer and in the range 20° C.-23.5° C. in winter) When the cartridge 1 is placed in the vessel 5, which is either filled with liquid 10 before or in which the liquid is poured after placing the cartridge, the ambient gasses will be trapped in the hollow space. Due to the trapped gasses, the hollow space remains at the ambient temperature when the infusion chamber is filled with liquid 10 of another temperature. The ambient gasses will be slightly compressed by upwards pressure of the liquid and exert a counter pressure on the liquid at the liquid-gas interface which keeps the liquid out of the open-bottomed bell.

The thermal element and the infusion chamber may have any shape suitable to induce the liquid flow therein. In the example of FIG. 2, the thermal element is placed such that the infusion chamber has the shape of a hollow cylinder, defined by the chamber wall 3 forming an outer cylinder and the thermal block forming the inner cylinder.

The thermal block extends in this example from the bottom of the infusion chamber 2 upwards. In the example of FIG. 3-4, the thermal block extends up to a level which lies, when the cartridge is in position and correctly oriented, at the same height as the rim of the cup 6 and hence to the maximum liquid level. Thereby, the full height of the infusion chamber is used to drive the liquid flow, and accordingly a fast infusion can be obtained.

The thermal block has in the examples a tapered-shape which tapers from a bottom of the infusion chamber upwards. This allows to mould the thermal block integrally with the chamber wall 3, e.g. in a single shot. However, alternatively, the thermal block may have parallel sides and form a right circular cylinder for example. In this example, the thermal block has a frusto-conical or conical shape.

The infusion chamber 2 may be implemented in any manner suitable for the specific implementation. In the example, the infusion chamber has a defined shape determined by the chamber wall 3. The chamber wall 3 is impervious to the liquid 12 in the infusion chamber 2 and, under normal circumstances, retains its shape when brewing tea. In FIG. 2, the chamber wall has a tapered-shape which tapers towards the bottom of the infusion chamber. Thus, the chamber wall and the thermal element can be moulded by e.g. injection or other moulding with two opposite mould parts, and the draft angle of the chamber wall is opposite to the draft angle of the heat exchange surface.

The thermal element may be located in any suitable position in the infusion chamber. For example, in FIG. 2 the thermal element is located co-axially with the infusion chamber but alternatively the thermal element may be located off-axis, for instance with its longitudinal direction parallel to that of the infusion chamber. The hollow cylinder formed between the thermal element and the chamber wall 3 has a radial width which in circumferential direction is constant. Thereby, the liquid flow will mainly be in the radial direction, and accordingly the exchange of liquid between the infusion chamber and the exterior be improved.

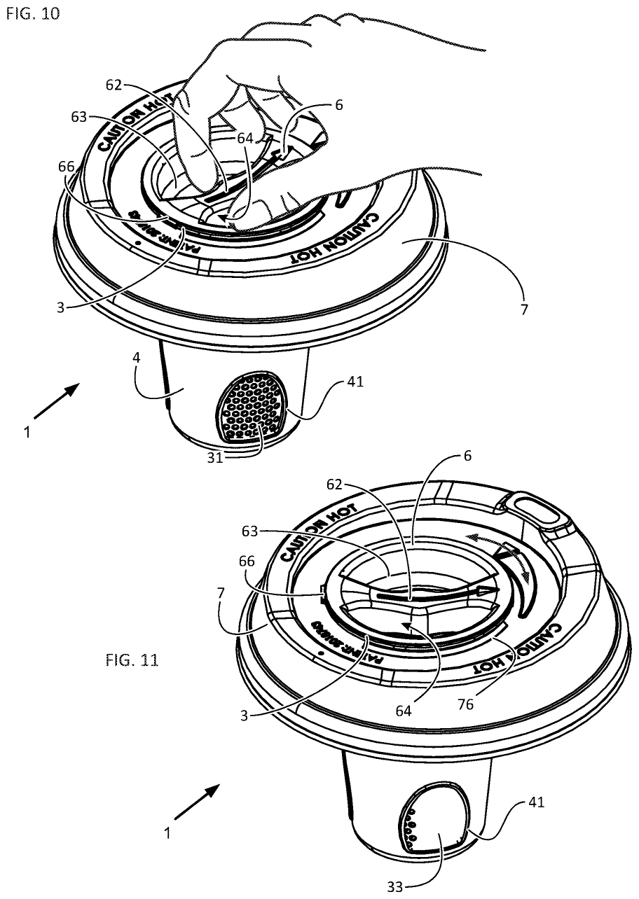

Referring now to the example of FIGS. 3 and 4, in this example the cartridge comprises several, separate parts, some of which are movable relative to each other. The passage 31 can be closed-off to stop the concentration of flavouring substances in the exterior from increasing. To that end, the passage 31 has an open state, as illustrated in FIG. 10, in which the infusion chamber 2 is in liquid communication with the exterior, to transfer the substances from the liquid 12 in the infusion chamber into the portion 12 of the liquid in the exterior during brewing tea, e.g. through convection and/or diffusion. The passage 31 has a closed state, illustrated in FIG. 11, in which the liquid 12 inside the infusion chamber is closed off from the liquid 11 in the cup outside the infusion chamber 2, and in which the concentration level of the flavouring substances in the liquid in the exterior is stopped from increasing.

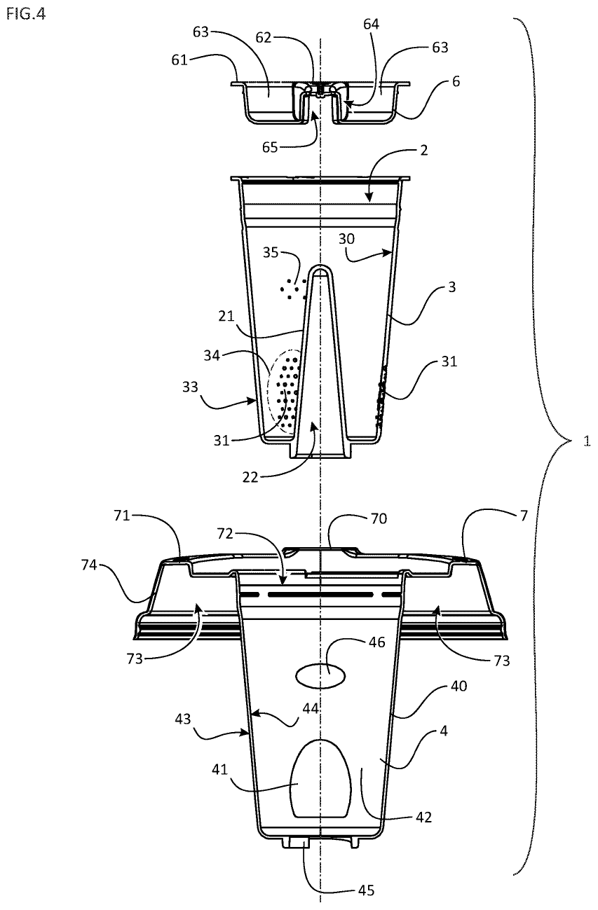

The cartridge 1 has a manual control 6 which is manually controllable by a human-being and allows to bring the passage 31 from the open state into the closed state, as illustrated in FIGS. 10 and 11. In this example, the manual control 6 is located at the top of the cartridge. It will be apparent from the FIGS. that in the shown example, the opening and closing is not motorized and that the cartridge does not have a machine powered actuator. In this example, a manual control is therefore the only manner in which a user can bring the opening into the open or closed state. This allows for a simple operation of the cartridge without a complex, e.g. battery operated, powered assembly being required. However, alternatively or additionally, the opening and closing may be motorized or motor-assisted. In this example, the passage 31 can be completely open, completely closed or be partially open. As shown in FIG. 5-6, the cartridge may be provided with an indicator 75 which indicates the extent to which the passage 31 is open. This allows the consumer to accurately control the concentration to his or hers taste.

When the passage 31 is open, the flavouring substances will be transported into the rest of the cup, e.g. by natural convection and/or diffusion in this example. In the rest of the cup during the brewing the transport is preferably solely by natural convection and/or diffusion. This allows to avoid messy situations since the infused liquid can then be transported throughout the vessel 5 without removing the cartridge 1. Alternatively or additionally to natural convection and/or diffusion, the transport may be driven mechanically. For example via the drinking funnel 70 described below, a spoon or stirring rod may be inserted to allow the consumer to manually stir the liquid.

In case the passages can be closed off, at a desired point in time, the passage 31 is brought in the closed state by a human-being, e.g. when the liquid 12 outside the infusion chamber 2 has a desired concentration of substances extracted from the tea leaves. By closing the passage 31 a consumer can manually control the strength of the tea to the individual's taste. The brewing of tea and especially the strength thereof can be stopped easily, without requiring removing the cartridge 1 from the vessel 5 as would be with the known tea-bag based solutions, and without requiring a dedicated computer interface to control the brewing. In addition, due to the flow drive system, in the open state the brewing is more constant.

Furthermore, in this example, the second aspect is implemented as well, and accordingly in the closed state the increase in concentration is further reduced because sealing of the passage is improved. This further allows to better preserve the tea (or other flavouring materials) prior to use because the improved sealing allow the infusion chamber 2 to provide a confined and protecting environment for the tea leaves and thus allows to prepare tea of a higher quality.

Also, in these examples, the third aspect is implemented, and the consumer can more easily transition the cartridge from the open state to the closed state (or vice versa).

In the example of FIGS. 3-4, the passage 31 can also be brought from the closed state back into the open state. Thus, a consumer can for example stop the brewing by closing the passage 31, taste the tea to determine if the strength matches the consumer's personal preferences, and reopen the passage 31 if the prepared tea is not strong enough to the individual's taste. Also, this allows to refill the cup with new liquid and prepare several cups of tea with a single cartridge. In such a case the cartridge 1 may be releasably attached to the vessel 5. Alternatively, the cartridge 1 may be permanently attached to the cup 1 to inhibit unwanted refills.

The cartridge 1 can e.g. be assembled with the passage 31 closed, such that the brewing does not start immediately upon bringing the cartridge 1 in thermal contact with liquid in a vessel 5 (either by placing the cartridge 1 in a liquid-filled cup or filling a cup in which the cartridge is placed with liquid) but only at a point in time the passage 31 is opened. This allows a user to select the point in time the liquid 12 outside the infusion chamber 2 actually starts being transformed into tea by opening the passage 31. Such can be convenient e.g. when the cup will be transported after filling with liquid and placing the cartridge, e.g. from the location where this takes place to a, relatively, remote location where the consumer will drink the tea (and after drinking dispose of at least the cartridge 1).

The chamber wall 3 has a liquid tight inner surface 30 facing the infusion chamber 2, which defines the inside of the infusion chamber 2, and an outer surface 33 facing away from the infusion chamber 2 towards the exterior.

The passage 31 comprises one or more openings 32 through the chamber wall 3 between the inner surface 30 and the outer surface 33. Although the opening may be implemented differently and for example be a single large opening, in this example, the chamber wall 3 comprises a perforated region 34 with a relatively large number of smaller openings, i.e. perforations. In the examples of FIGS. 2-4, the chamber wall 3 is of a closed material, except for the perforated region 34. Thus, the openings can be created in a simple manner, e.g. by simply perforating the region 34, and allows to create a passage which can retain the tea leaves in the infusion chamber. The perforations can be sufficiently small to retain loose tea leaves in the infusion chamber 2, such as with a diameter equal to or less than 5 mm, e.g. equal to or less than 2 mm, such as equal to or less than 1 mm, although other sizes may be suitable as well. The perforations may have the same diameter or differ in diameter. Furthermore, the perforations may be arranged in a matrix arrangement of e.g. horizontal and/or vertical series, as can be seen in FIG. 3 for example. Also, although in this example the passages are separated in circumferential direction of the chamber wall 3, and several spaced apart regions 34 are present, in an alternative implementation the chamber wall is provided with a band of perforations extending circumferentially and hence one or more in circumferential direction continuous regions for example.

In the shown example, the cartridge 1 further comprises an outer wall 40. The chamber wall 3 and the outer wall 40 are made of a material which is impervious to the liquid. Except for the openings 32, the chamber wall 3 thus closes-off the infusion chamber 2. Where the outer wall 40 covers the outer surface 33 of the chamber wall 3, these covered parts are separated, e.g. sealed, from the exterior by the outer wall 40. When the outer wall 40 covers an opening 32, the opening 32 is thus closed off for the liquid 12 outside the infusion chamber 2.

As can be seen in FIGS. 5 and 6 and as illustrated in FIG. 6 with the arrow, the chamber wall 3 is movable relatively to the outer wall 40 to cover, and close, the opening 32 in the chamber wall 3. This allows a mechanically simple manual control, e.g. by manually sliding, rotating or otherwise moving the outer wall 40 relatively to the chamber wall 3 The double wall construction with a chamber wall 3 and an outer wall 40 which are movable relative to each other, allows the passage 31 to be implemented in various manners.

As can be seen in FIGS. 5 and 6, here the outer wall 40 comprises one or more apertures 41, which leaves a part of the chamber wall 3 exposed. The manual control 6 engages in this example on the chamber wall 3 to move the chamber wall relative to the outer wall 40, to position the aperture 41 to overlap with the opening 32, in this example the perforated region 34, in the chamber wall 3 and thereby bring the passage 31 in the open state. However, the opening 32 in the chamber wall 3 can be implemented differently and, e.g. as one or more narrow slits, as can be seen in FIG. 2. Likewise, instead of the aperture 41, the outer wall 40 may be provided with another type of window, such as perforations, slides or otherwise which can be moved to expose the opening in the chamber wall 3 to the exterior. Furthermore, the manual control 6 may instead of engaging on the chamber wall 3 to move the chamber wall 3 relative to the outer wall 40 with the outer wall static relative to the user, engage on the outer wall 40 to move the outer wall relative to the chamber wall 3 and to the user.

In the shown example, the chamber wall 3 is shaped as a container for the loose tea leaves and the outer wall 40 is shaped as a holder 4 which holds the container. The container is movable relative to the holder 4 to bring the passage into the open state or the closed state. This allows to assemble the cartridge 1 in a simple manner, by simply placing the container in the holder 4. However, the chamber wall 3 may have a different shape and, e.g. be a hollow ring or toroid which is provided on the radial inside with a passage that can be closed-off by an outer wall that can move along the radial inside in tangential direction to cover or expose the passage 31. Also, the chamber wall 3 may e.g. be a rectangular cuboid, just to name a couple of examples.

In the shown example, the chamber wall 3 is rotatable (relative to the outer wall 40) around a longitudinal axis L thereof. As best seen in FIG. 3, in the example of FIGS. 3-4, the chamber wall 3 is shaped as a first tube with an outer diameter smaller than an inner diameter of the outer wall 40, which is shaped as a second tube. As shown, at least one of said tubes is closed off at a cup-side end, in the drawings at the bottom thereof. This ensures that the leaves and liquid are retained in the infusion chamber 2 when the passage is closed off. The second tube is open at a top side end, which allows to insert the first tube and, hence, assemble the cartridge 1. Such tubes can be shaped without undercuts and hence manufactured in a simple manner e.g. using a one-piece mould.

As shown, the tubes can fit tightly. An outer surface of the first tube abuts in this example to an inner surface of the second tube when the first tube is inserted in the second tube. This allows an opening and/or closing movement while having a sufficient sealing of the opening when the passage 31 is closed. The tubes are just an example where the outer wall 40 and the chamber wall 3 are both cup-shaped. Other types of cup shapes, such as conforming bowls or other shapes may be suitable as well.

The chamber wall 3 fits tightly into the outer wall. When moving the walls relative to each other there will, therefore, be some friction which allows to ensure that the outer wall seals of the covered parts of the chamber wall in a simple manner.

The outer wall 40 may have a different shape and for example, be a sheet which covers only a part of the chamber wall and which can be slid to cover the outer surface 34, be a flat leg-shaped member which is slideably clamped on the chamber wall 3 or be a sleeve provided with a suitable aperture in which the container is inserted and which can be rotated to expose the opening in the chamber wall 3, as shown in FIG. 8 to just name a few.

Still referring to FIGS. 3 and 4, in the example the cartridge 1 comprises a top, lid-shaped portion 7 which covers the vessel 5. The lid-shaped portion 7 covers the cup and thus reduces exchange of thermal energy with the ambient environment, e.g. heat losses in case of a hot drink, and accordingly slows down the dropping of the temperature of the tea in this example. The lid-shaped portion 7 is provided with a drinking funnel 70 which enables the user to drink the liquid 12 in the cup outside the infusion chamber 2 when the cartridge 1 is in place, without removing the lid-shaped portion 7 and hence without increasing said exchange of thermal energy.

The portion 7 comprises a disk-shaped, annular part 71, from here on referred to as an annular flange 71. The annular flange 71 can be attached to the top-rim of the cup or other vessel. In this example, the annular flange 71 can be attached to the top-rim by an interlocking engagement between the top-rim and an edge of a skirt 74 which projects downwards from the outer edge of the annular flange 71. The lid-shaped portion 7 can for example be permanently attached, i.e. only destructively releasable, which can be suitable for a disposable cartridge 1. Alternatively, the cartridge 1 may be releasably attached to the vessel 5, e.g. using a releasable water-tight, seal, e.g. in case of a non-disposable cartridge. In the shown example the annular flange 71 has the shape of a mathematical annulus, but alternatively, the opening, referred to as the axial passage 72 below, may have a non-circular shape, such as rectangular, elliptical or otherwise, and/or be off-axis relative to the outer edge of the annular. Alternatively or additionally, instead of a circular outer edge, the outer edge of the flange 71 may have another shape, e.g. polygonal, elliptical or otherwise.

The example of FIGS. 1-4 comprises an excess liquid outlet 35 in the chamber wall which is located above the passage, for transferring excess liquid from the infusion chamber 2 when the cartridge 1 is tilted around a horizontal axis. The outer wall 40 is provided with a corresponding spill-over aperture 46 which is open when the passage 31 is closed, to drain excess liquid from the infusion chamber 2 when drinking. More specifically, when the cup in which the cartridge 1 placed is tilted to start drinking, the excess liquid outlet 35 will be at the lower side (i.e. towards the user) and excess liquid will be drained out of the chamber into the exterior by gravity. When the cup is turned back in upright position, the liquid level outside the chamber will be lower than the excess liquid outlet 35 and, hence, not flow back into the chamber. This allows to avoid messy situations caused by a dripping container.

In the example of FIGS. 3-4, the chamber wall 3 extends from the lid-shaped portion 7 and encloses the infusion chamber. More specifically, in this example, the lid-shaped portion 7 is part of an integral member which is formed into the outer wall 40. As best seen in FIG. 4, the inner peripheral edge of annular flange 71 of the lid-shaped portion 7 is attached to the outer wall 40, such that the outer wall forms a pouch-shaped holder 4 behind the passage 72 through the annular flange 71. In the pouch-shaped holder 4 the chamber wall 3 can be received. Said differently, the passage 72 is a blind hole in which the infusion chamber can be fitted.

The lid-shaped portion 7 has a shape which allows it to be nested with similar components. Likewise, the chamber wall 3 has a shape which allows it to be nested with similar components. More specifically, the axial passage 72 and the chamber wall 3 have a tapered shape, which narrows towards the bottom. This allows to nest multiple chamber walls and to nest multiple lid-shaped portions 7. In addition, this provides a strong construction which resists torque induced deformation with a relatively thin wall, which in addition can be mass manufactured with a mould.

In the shown example, in addition, the lid-shaped portion 7 is strengthened to withstand torque induced deformation. More specifically, the annular flange 71 is profiled and has an outer, peripheral rim which projects upwards and which, in this example, has a cross section of a U-shape turned upwards down, with a skirt 74 at the peripheral, outer, edge of the rim which projects downwards to interlock on the rim of the cup. The rim on the lid has thus been elevated, which provides additional strength to withstand the friction, and torque resulting therefrom, when opening and closing the chamber wall by rotating the chamber. This strengthening allows to have relatively thin, not so rigid, material like thermoplastics or paper. Between the skirt 74 and the holder 4 a hollow space 73 is thus formed, which is open at the bottom and at the top closed off by the annular shape of the lid-shaped portion 7. When placed on the cup 5, the hollow space 73 is located above the cup

The chamber wall 3 can be inserted through the axial passage into the holder 4, i.e. the outer wall 40. Thus, for example, a vessel 5 can be prefilled with hot liquid and covered with the lid-shaped portion 7 to avoid the liquid from cooling too fast. A period of time thereafter, the container formed by the chamber wall 3 can be inserted into the holder 4 to start the brewing in the infusion chamber 2. The container can e.g. be prefilled with tea leaves o be filled with tea leaves after being inserted in the holder 4.

As shown, the cartridge 1 can comprise a cover 6 for covering a top-side of the space (i.e. the infusion chamber 2) enclosed by the chamber wall 3 and which interlocks therewith. Thereby, e.g. the infusion chamber 2 can be pre-filled with loose tea leaves, closed off and be placed on for instance a shelf to wait for a customer to order a cup of tea.

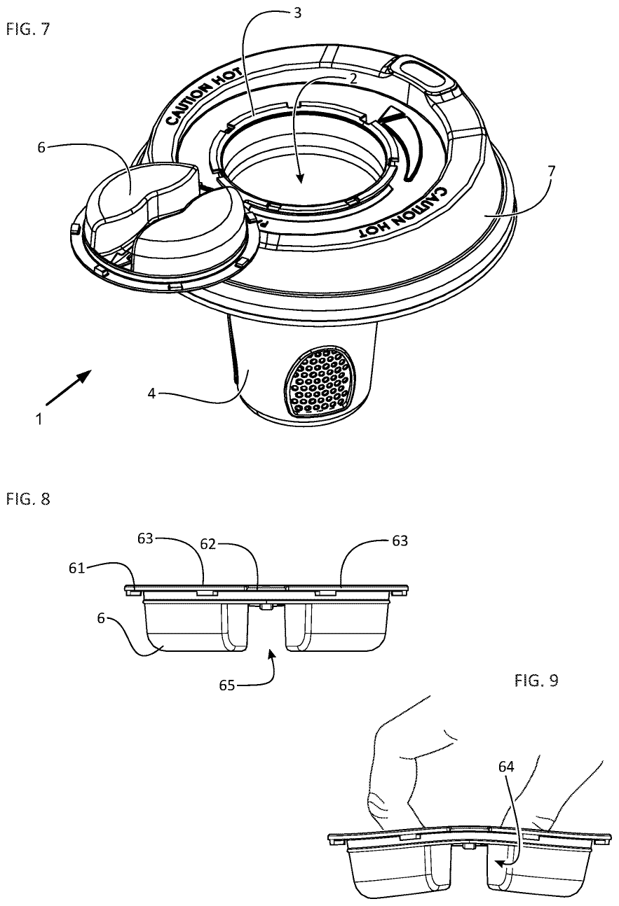

Referring now to FIGS. 7-10, as mentioned, in the cartridge 1 the third aspect may be implemented. FIG. 7 shows the manual control 6 removed from the cartridge. As best seen in FIGS. 8 and 9, the manual control allows a user to exert a manual force and open or close the opening. In this example, the force is exerted from the top-side of the cartridge, more specifically as a torque around the rotational axis of the infusion chamber. The manual control 6 is in this example a cover for covering an, open, top-side of the chamber wall 3 and close-off the entrance 20 to the infusion chamber 2. When in position, the cover engages with the chamber wall 3 and rotation of the cover 6 relative to the outer wall 40 rotationally moves the chamber wall 3 relative to the outer wall 40 as well. Although the cover 6 may have a different shape, in this example the cover is shaped as a rotary knob rotatable relative to the outer wall and mechanically attached to the chamber wall 3 to transfer the rotational movement of the rotary knob to a rotational movement of the chamber wall 3.

As can be more clearly seen in FIG. 5, the lid-shaped portion 7 is provided with a circumferential rib 76 which extends along the edge of the axial passage 72. The rib 76 defines the range of rotational motion of the manual control 6. The circumferential rib 76 projects upwards from the annular flange 71. In a gap between respective ends of the rib 76 a stopper 66 of the movable control 6 is located when the movable control 6 is in engaging position with the chamber wall 3, as is shown in FIG. 11. The angular range of motion of the movable control is defined by the position in which the stopper 66 abuts to the end of the rib 76 at one side of the gap, and the position in which the stopper 66 abuts to the end of the rib 76 at the other side of the gap. Thereby, the user is provided with a haptic indication of the position. This may be in addition or as alternative to the visual indication of the position.

The shown example of a cover 6 comprises a cup-shaped grip 61 which is partitioned in upwards open parts 63, in this example two parts 63, for admitting different fingers of the user. A partitioning wall 62 with sidewalls 64 separates the upwards open parts 63 and allows to manually exert with the fingers a rotational force. The partitioning wall extends radially from a peripheral edge of the grip inwards. As shown, the partitioning wall 62 has in the centre of the grip 61 a larger thickness and subdivides each part 63 in two locations, each for a respective finger. It is found that, without wishing to be bound to theory, most users will insert a thumb in one part 63 and index finger and middle finger the other part. As illustrated in FIG. 9 by exerting with the fingers a squeezing force on the partitioning wall, the edge can be deformed to release the interlocking engagement between the cover and the chamber wall.

In this example, the partitioning wall 62 has an inverted U-shaped cross-section, with the side walls forming the legs of the U-shape and only being connected to each other at the upper lateral side. An open space 65 is thus present between the sidewalls. This provides relatively rigid side walls. The walls can be brought together by the squeezing with relatively little force to release the interlocking but are stiff in the tangential direction of rotation. This allows to swiftly rotate the manual control to open or close the passage.

The sidewalls 64 project from the bottom of the cup-shaped cover, which the user can pinch between his fingers because the distance between the sidewalls and the edge of the cup cover is sufficient to admit a fingertip in the recess between the elongated projection and the rim. The rotational force on the partitioning wall 62 will rotate the cover 6 and, by the interlocking attachment, rotate the chamber wall 3. In this example, the recess is divided in two open parts, but alternatively, this can be divided in more parts, e.g. by a cross-shaped partitioning wall.

As best seen in FIG. 8, the shown example of a cover 6 has a rim, which interlocks with the chamber wall 3. The cover 6 can lock permanently, i.e. is not releasable without excessive force and without damaging the cover 6 and/or the chamber wall 3. This allows to stop unwanted reuse by e.g. refilling the infusion chamber 2 with fresh leaves after use. However, alternatively as in the shown example, the cover 6 may be releasably attached to the chamber wall, e.g. by the squeezing release of the interlocking as explained above. The attachment of the cover 6 to the chamber wall 3 allows to exert a rotational force on the chamber wall 3.

The manual control, cover 6 in this example, and the lid-shaped portion 7 may both be provided with an optical marker that is visually perceptible by a human, to indicate their relative position, and to allow a user to identify whether or not the passage 31 is open or closed. For example in FIGS. 5-6, the partitioning wall 62 itself can be used as an optical marker and the lid-shaped portion 7 can be provided with one or more indicator(s) 75 towards which the partitioning wall 62 points, when the passage 31 is open or closed.

In the shown example, the cover 6 is separated from the cup. However, the cover 6 may be attached to the cup, or to the cartridge prior to use, e.g. by tearable strip between the cover and the other part.

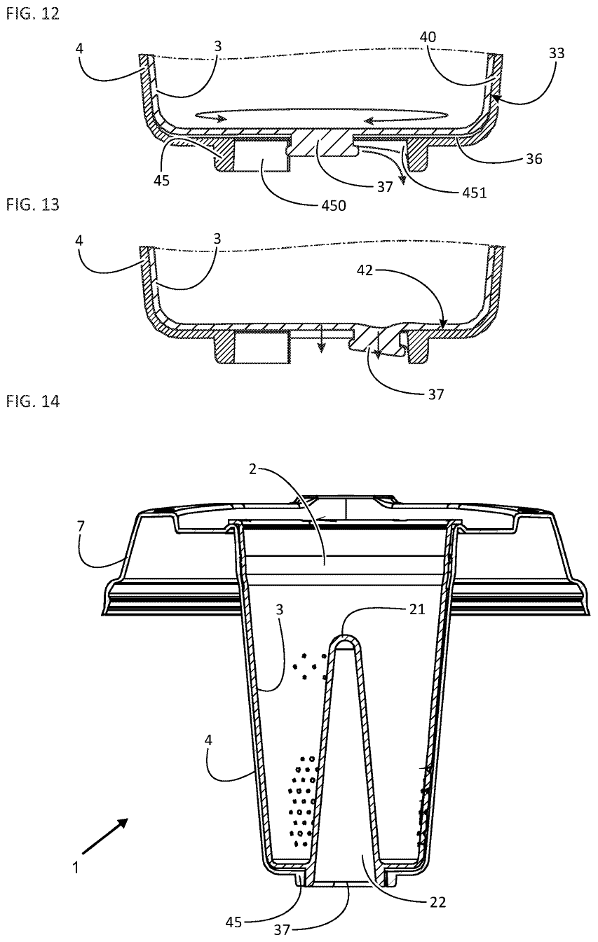

Referring to FIG. 12-13, the example of a cartridge shown therein is provided with the second aspect. In this example, upon moving the outer wall, the outer surface 33 is pressed onto the outer wall 40 to seal off the opening in the closed state as follows. In this example the outer surface 33 is moved and pressed against the outer wall, but it will be apparent that alternatively or additionally, the outer wall 40 may be moved to be pressed against the outer surface 33.

As illustrated in FIG. 12, in the open state, an interstitial space 36 is present between the chamber wall 3 and the outer wall 40. In this example, this interstitial space 36 reduces the friction between the chamber wall 3 and the holder 4, and thus reduces the effort the user has to deliver to move the chamber wall 3 relative to the holder 4.

When bringing the cartridge in the closed state, the bottom side 37 of the chamber wall 3 is pulled downwards and pressed against the outer wall 40. As illustrated, in this example the bottom part 45 of the holder 4 is part of a tube, which in this example is open but may e.g. be closed off at the bottom-side of the bottom part 45. The inside diameter at the bottom part 45 is smaller than the inside diameter of the holder 4 above the bottom part, and smaller than the diameter of the outer surface 33 of the chamber wall 3. As shown, in this example the inside 42 of the holder 4, that is the tube, has a stepped profile, with the chamber wall 3 in the part with the larger diameter above the step. Thus, when the bottom side 37 is pulled downwards, the interstitial space 36 will be reduced until the outer surface 33 abuts to the inside 42 of the holder 4.

Although the bottom side 37 can be pulled downwards in another manner, in this example the bottom side 37 is pulled downwards by transforming the rotational movement of the chamber wall 3 partially in a longitudinal movement of the bottom 37. It will be apparent that the top of the chamber wall 3 is inhibited from moving by the interlocking with the holder 4 at the top, and hence the chamber wall 3 will be stretched in the axial direction by the longitudinal movement of the bottom side 37. The chamber wall is closed-off at the bottom and the bottom side 37 of the chamber wall 3 projects, in the longitudinal direction of the tube downwards, into the bottom part 45. The bottom part 45 has a guide path 451 for this bottom side 37 which extends in the direction of rotation and is bend in the axial direction. As shown, upon rotation, the guide path 451 guides the movement of the bottoms side 37 to be downwards in the longitudinal direction of the tube. As illustrated in FIG. 13, the bottom side 37 is elastically deformable and slides over the guide path 451 upon rotation of the chamber wall 3. This slightly deforms the bottom side, and the elastic deformation is transferred onto the chamber wall 3 to press the outside surface 33 against the inside 42 of the holder.

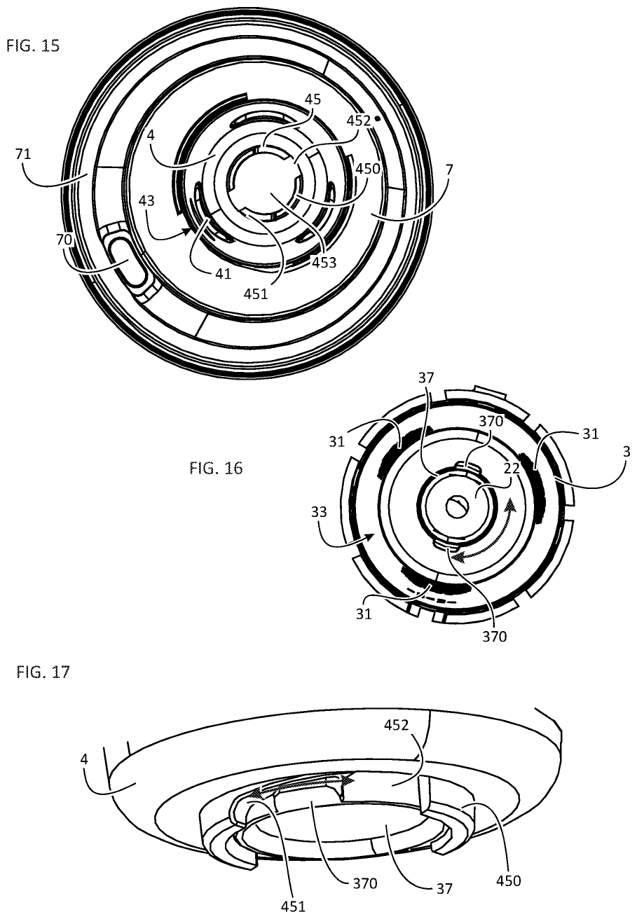

FIG. 14-17 show the second aspect in the example of FIG. 3-4. As can best be seen in FIG. 16, in this example the bottom side 37 is provided with radially projecting lips 370 which when the chamber wall 3 is in the holder 4 project over the guide part 451. To place the chamber wall 3 in the holder 4, the bottom part 45 is provided with an opening with a shape corresponding to that of the bottom side 37, i.e. with a central opening 453 through which the projecting part of the bottom side 37 passes and a radial cut-out 452 through which the lips 370 can pass. By after inserting rotating the chamber wall 3 the lips 370 can come to slide over the guide path 451. As shown, the opening in the bottom part 45 is delimited by a circumferential wall 450 on which the guide path 451 is provided, and which is interrupted by the cut-outs 452. The path 451 forms a sloping part of the circumferential wall 450 which starting from the cut-out 452 projects downwards. When rotating the chamber wall 3, the lips 370 will slide over the sloping part, and thus in addition to making the rotational movement, be moved downwards, in the axial direction. This stretches in turn the chamber wall 3 such that the chamber wall is pressed against the inside 42 of the holder. Accordingly, a good sealing between the chamber wall 3 and the holder 4 is provided which prevents, and preferably completely stops, seeping of liquid out of the infusion chamber 2 in the closed state of the cartridge.

In the shown examples, the outer wall and/or the chamber wall and/or the cover each have a top side with a shape which conforms to the bottom side. Thus, the outer wall and/or the chamber wall and/or the cover are nestable and several outer walls and/or chamber walls and/or covers can be stacked onto each other in a compact manner.

The cartridge, and the cup (if provided with the cartridge), may be manufactured in any manner suitable for the specific product. For example, the components may be manufactured with one or more of the production methods summarized below, not leaving out other production methods. For example, the cartridge may be manufactured with:
extrusion;
blow extrusion;
injection molding;
blow molding;
rotational molding; or
any other suitable production methods.

The product and its components can be made from any suitable material or combination of disposable or non-disposable materials, such as metal, glass, plastic or cardboard. The material may e.g. be a recyclable material or a biodegradable material, for example. Below is a summary of possible materials, which could be used although other materials can be suitable for production as well.

Examples of suitable materials are aluminium, glass, wood, plastics or paper and/or paperboard.

A suitable plastic-based material may for example be a material selected from the group consisting of: Plastic coated paper; Polystyrene or Styrofoam; Polypropylene (PP); Polyvinyl chloride (PVC); Polyethylene (high or low density HDPE/LDPE) and or polyethylene Terephthalate (PETE); or other plastics. Suitable paper and/or paperboard materials can for example be one or more materials selected from the group consisting of: Paper, Paperboard, Corrugated fibreboard, Molded pulp from recycled newsprint or from other materials. The paper or cardboard materials may e.g. be coated or non-coated with additional materials like plastic amongst other materials.

Alternative materials (natural and/or biodegradable and/or composite) can for example be:
Combination of natural starches, recycled fibers, water, air and natural minerals;
PLA (polylactic acid);
Mixture of PLA and pulp fibers;
Composite or mixture of starch and other materials such as Limestone and recycled fibers to provide additional strength;
Dry fallen leaves of trees like the areca catechu palm (betel tree) which are collected and hot pressed into the desired form of the lid;
PDC (prodegradant concentrates) containing polymers (PDC's);
Biodegradable plastic made from e.g. milk protein, like casein;
Keratin based water resistant thermoplastic, e.g. made of chicken feathers;
Liquid wood which feels and acts like plastic and is biodegradable.
Polycaprolactone polyesters degradable after weeks of composting.
Biodegradable plastics of polyhydroxyalkanoate polyesters;
Crystallized Poly Lactic Acid;
Cellulose based materials.

In the foregoing specification, the invention has been described with reference to specific examples of embodiments. It will, however, be evident that various modifications and changes may be made therein without departing from the broader scope as set forth in the appended claims. For instance, although the preceding tea leaves have been described, it will be apparent that instead or additionally to tea leaves other flavouring materials may additionally or alternatively be used.

The infusion chamber may contain other solid particles in the chamber which release flavouring substances in hot water, such as herbs, sliced citrus fruits, or otherwise. Likewise, the flavouring materials may comprise or consist of another material releasing flavouring substance or substances, such as non-soluble solid particles which release such substance, soluble solid particles, or a liquid flavouring (such as a liquid extract or concentrate). Also, the flavouring materials may be release flavouring substances in cold or lukewarm water. The liquid may be any type of liquid suitable to prepare the desired type of beverage, such as hot water, cold water, milk, aqueous liquid, lemon juice, or mixtures thereof.

Also, the various components may be made from the same materials, or from different materials, in order to achieve optimal strength and closure of the liquids. For instance, where in the examples or claims a chamber wall 3 is shown, it will be apparent that this implies that the wall 32 retains under normal circumstances its shape when brewing tea, but that the wall may be subject to some resilient or plastic deformation when opening or closing the passage 31.

Also, in the examples the outer wall closes or seals off the covered parts of the chamber wall. It will be apparent that this does not need to be a liquid tight seal and that some liquid may seep between the chamber wall and the outer wall as long as for practical purposes the concentration of flavouring substances in the cup outside the infusion chamber does not noticeably increase during typical use.

Furthermore, although in the figures the cartridge 1 is shown as an assembled product, the cartridge 1 may be provided as a kit of parts which can be assembled to form the cartridge. For example a container 3 or other type of infusion chamber may be filled with loose tea leaves and closed (e.g. by placing a cover 6 on an open top-side of the container) and placed in a holder 4 to obtain an assembled product. Likewise, the cartridge 1 can be provided as part of an assembly of a cartridge and a cup and for example be packaged together. Also, the cartridge 1 may be pre-mounted on the cup, such that the final, finished product comprises of the cartridge mounted on the cup, and that the assembly is ready for use after unpackaging.

The cartridge 3 and/or cup 4 can be made of any suitable material, such as coated or waxed paper or plastic.

Furthermore, although in the example the passage 31 is provided at the longitudinal surface or side of the infusion chamber 2, it will be apparent that e.g. the chamber wall 3 may be provided with a passage at the bottom 37 which can be opened/closed with a rotary disk, e.g. a rotary disk provided with slots which in the open state coincide with the passage and in the closed state do not overlap with the passage.

Likewise, although in the examples, the chamber wall 3 is rotatable, relative to the outer wall 40, around the axis of the infusion chamber 2 other ways of moving the chamber wall and the outer wall relative to each other are also possible. Alternatively for example the outer wall 40 may be translationally movable, e.g. in the longitudinal direction or in the transfer direction of the chamber wall 3, and the chamber wall 3 may be non-tapered for instance. Furthermore, the passage may e.g. be closable by moving the outer wall downwards relative to the chamber wall (or vice versa), i.e. in a longitudinal direction from the top of the cartridge towards the bottom to cover the passage.

Also, in the shown examples, the openings 32 have a small dimension, sufficiently small to retain the solid, non-soluble parts of the flavouring substances (i.e. in the examples the tea-leaves) in the chamber. However, the passage may have one or more openings with a larger diameter, larger than those parts and e.g. be covered with a filtering mesh to retain the parts in the infusion chamber.

Also, the cartridge can be compartmentalized in order to provide more variation of the extracts as well as usage of sugar, syrup and the sorts. Instead of a single infusion chamber, for example, the cartridge may include various chambers filled with flavouring substances, such as solid, non-soluble parts from which flavouring substances can be extracted or extracts (i.e. concentrated flavouring liquids or soluble solids). Each of the chambers has a respective passage in the chamber wall. A controlled release of the different flavouring substances into the cup can then be obtained by opening and closing the passages in an order and for a duration controlled by the consumer. For example, one or more chambers with aromatic flavourings may be opened first to give the liquid a base flavouring, such a tea, fruit or other flavour, and closed after a period of time determined by the consumer. Thereafter, a chamber with a sweeting flavouring, e.g. sugar or another soluble sweetener, can be opened, which again is closed after a period of time determined by the consumer. Also, a chamber with e.g. dairy products may be provided, such as with milk powder or sterilized milk.

In addition, or alternatively, in the cartridge sealed-off reservoirs (pre-)filled with extracts may be provided, which are sealed-off with a sealing strip. The reservoirs may be opened to release the extract by removing, e.g. tearing, the sealing strip from the reservoir, which allows the extract to mix with the liquid. The sealing strip then ensures that the cartridge with extract will not leak until usage in the lid.

It can also be imagined that advertisement or other graphics can be printed on the side of the cartridges and the lid during production. For example, at a top of the lid-shaped portion 7 or other position visible to the outside world during the brewing, the graphics may be printed (e.g. by applying a suitable ink or paint pattern, engraving or otherwise).

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances, such that the embodiments described herein are, for example, capable of operation in other orientations than those illustrated or otherwise described herein.

Likewise, where a movement of an object is described (e.g. relative to another object) it will be apparent that this is a relative movement, and accordingly depending on the chosen reference frame, the object may be moving relative to an observer while the other object is static, the other object may be moving while the object is static relative to the observer or both objects may be moving, but differently, relative to the observer.

Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

### REFERENCE NUMBERS

Fe exterior flow direction
Fi infusion chamber flow direction
L longitudinal axis
1 cartridge
2 infusion chamber
3 chamber wall
4 holder
5 vessel
6 cover
7 top, lid-shaped portion
8 flow drive system
9 solid substances
10 liquid
11 exterior liquid
12 infusion chamber liquid
20 entrance infusion chamber
21 thermal block
22 opening
23 heat exchange surface
30 inside surface
31 passage
32 opening
33 outer surface
34 perforated region
35 excess liquid outlet
36 interstitial space
37 bottom part
40 outer wall
41 aperture
42 inside
43 outer surface
44 chamber wall facing surface
45 bottom part
46 spill over aperture
60 cup-shaped grip
61 peripheral edge
62 partitioning wall
63 upwards open part
64 side wall
65 open space
66 stopper
70 drinking funnel cup-shaped grip
71 outer annular flange
72 axial passage
73 hollow space
74 skirt
75 indicator
76 rib
370 radial lips
450 circumferential wall
451 guide path
452 cut-out
453 opening

1. A cartridge for preparing a flavoured drink, the cartridge comprising:
an infusion chamber for containing flavouring materials, and infusing a liquid with flavouring substances from the flavouring materials;
a chamber wall which defines the infusion chamber;
a passage in the chamber wall between the infusion chamber and an exterior thereof, for exchanging liquid between the infusion chamber and the exterior of the chamber;
the cartridge further having at least one of (i), (ii) and (iii):
(i):
the cartridge comprises a flow drive system arranged to, when the flow drive system is in operation, drive during infusion in the infusion chamber a liquid flow between the infusion chamber and the exterior of the chamber through the passage, the liquid flow having in at least a part of the infusion chamber a flow direction which projects from the chamber wall;
(ii):
the chamber wall has a liquid tight inner surface facing the infusion chamber which defines the inside of the infusion chamber, and an outer surface facing away from the infusion chamber towards the exterior;
the passage comprises an opening in the chamber wall between the inner surface and the outer surface; and
the cartridge further comprises an outer wall covering at least a part of the outer surface, and which is movable relative to the chamber wall to cover and close the opening in the chamber wall; and
wherein upon moving the outer wall, the outer surface is pressed onto the outer wall to seal off the opening;
(iii):
the cartridge comprises a manual control for exerting a manual force by the user to open or close the passage, the manual control comprising:
a cover for covering a top-side of the chamber wall, the cover interlocking with the chamber wall, wherein the cover comprises:
a cup-shaped grip which is partitioned in a first upwards open part for admitting at least one finger of the user and a second upwards open part for admitting at least one other finger of the user, and
a partitioning wall with sidewalls for manually exerting with the fingers a rotational force, the partitioning wall separating the upwards open parts, the partitioning wall extending radially from a peripheral edge of the grip inwards, and wherein by squeezing with fingers on the partitioning wall, the edge can be deformed to release the interlocking.

2. The cartridge of claim 1, wherein the flow drive system comprises or consists of a non-mechanical system.

3. The cartridge of claim 2, wherein the flow drive system comprises a thermal convection system and the liquid flow is thermally driven.

4. The cartridge of claim 3, wherein the thermal convection system comprises a thermal element located in the infusion chamber for differential heating or cooling of the liquid in the infusion chamber.

5. The cartridge of claim 4, wherein the differential heating or cooling by the thermal convection system induces a free convection flow in the infusion chamber.

6. The cartridge of claim 4, wherein the thermal element is a thermal block which comprises:
a heat reservoir;
a heat exchange surface which is exposed in the infusion chamber, for transferring thermal energy from or to the liquid in the infusion chamber and to or from the heat reservoir.

7. (canceled)

8. The cartridge of claim 6, wherein the heat reservoir is a heat sink and thermal energy is transferred from the liquid into the heat reservoir.

9. The cartridge of claim 6, wherein the heat exchange surface projects from the chamber wall into the infusion chamber.

10. The cartridge of claim 6, wherein the heat reservoir comprises a volume defined by the heat exchange surface which is filled, or fillable, with a fluid different from the liquid.

11. The cartridge of claim 10, wherein:
the fluid is air;
the volume projects into the infusion chamber and is a cavity which has an opening to the exterior for trapping air, and the cavity sealed from the infusion chamber by the heat exchange surface.

12. The cartridge of claim 11, wherein the cavity projects from the outside surface of the chamber wall into the infusion chamber, from the bottom of the infusion chamber upwards.

13. The cartridge of claim 6, wherein the infusion chamber has the shape of a hollow cylinder, defined by the chamber wall forming an outer cylinder and the thermal block forming an inner cylinder.

14. The cartridge of claim 13, wherein the thermal block has a tapered-shape which tapers from a bottom of the infusion chamber upwards.

15. The cartridge of claim 14, wherein the thermal block has a frusto-conical or conical shape.

16. (canceled)

17. (canceled)

18. The cartridge of claim 1, wherein the liquid flow is from the exterior, circulating in the infusion chamber, to the exterior.

19. (canceled)

20. (canceled)

21. The cartridge of claim 1, wherein the liquid flow comprises, in a flow-direction:
an inflow from the exterior, through the passage,
a circulating flow in the infusion chamber which passes through flavouring materials containing space of the infusion chamber, and
an outflow through the passage from the flavouring materials containing space to the exterior.

22. The cartridge of claim 1, wherein the passage comprises a region in the chamber wall with at least an upper opening and a lower opening, and wherein the liquid flow through the upper opening is into the infusion chamber and the liquid flow through the lower opening is out of the infusion chamber.

23.-35. (canceled)

36. The cartridge of claim 1, wherein the cartridge has option (ii) and a bottom part of the chamber wall rotatably interlocks with the outer wall and wherein the bottom part is tensioned downwards when closing the opening.

37.-49. (canceled)

50. An assembly of a cartridge and a, disposable or non-disposable, vessel for containing liquid, the vessel comprising a top rim on which the cartridge fits,
the cartridge comprising:
an infusion chamber for containing flavouring materials, and infusing a liquid with flavouring substances from the flavouring materials;
a chamber wall which defines the infusion chamber;
a passage in the chamber wall between the infusion chamber and an exterior thereof,
for exchanging liquid between the infusion chamber and the exterior of the chamber;
the cartridge further having at least one of (i), (ii) and (iii):
(i):
the cartridge comprises a flow drive system arranged to, when the flow drive system is in operation, drive during infusion in the infusion chamber a liquid flow between the infusion chamber and the exterior of the chamber through the passage, the liquid flow having in at least a part of the infusion chamber a flow direction which projects from the chamber wall;
(ii):
the chamber wall has a liquid tight inner surface facing the infusion chamber which defines the inside of the infusion chamber, and an outer surface facing away from the infusion chamber towards the exterior;
the passage comprises an opening in the chamber wall between the inner surface and the outer surface; and
the cartridge further comprises an outer wall covering at least a part of the outer surface, and which is movable relative to the chamber wall to cover and close the opening in the chamber wall;
and wherein upon moving the outer wall, the outer surface is pressed onto the outer wall to seal off the opening;
(iii):
the cartridge comprises a manual control for exerting a manual force by the user to open or close the passage, the manual control comprising:
a cover for covering a top-side of the chamber wall, the cover interlocking with the chamber wall, wherein the cover comprises:
a cup-shaped grip which is partitioned in a first upwards open part for admitting at least one finger of the user and a second upwards open part for admitting at least one other finger of the user, and
a partitioning wall with sidewalls for manually exerting with the fingers a rotational force, the partitioning wall separating the upwards open parts, the partitioning wall extending radially from a peripheral edge of the grip inwards, and wherein by squeezing with fingers on the partitioning wall, the edge can be deformed to release the interlocking.

51. (canceled)

52. (canceled)

53. A method of preparing a flavoured drink, with a cartridge placed in a liquid containing vessel, the vessel filled at least partially with a liquid suitable to prepare a flavoured drink with flavouring materials, the cartridge comprising:
an infusion chamber containing the flavouring materials, a space of the vessel outside the infusion chamber forming the exterior of the chamber;
a chamber wall which defines the infusion chamber; and
a passage in the chamber wall between the infusion chamber and the exterior of the chamber,
the method comprising:
exchanging, through the passage liquid, between the infusion chamber and the exterior of the chamber;
flavouring the liquid in the infusion chamber with flavouring substances from the flavouring materials in the infusion chamber; and
performing one, or more than one, or all, of (i)-(iii):
(i) during said flavouring, a flow drive system in the infusion chamber driving a liquid flow between the infusion chamber and the exterior of the chamber through the passage, the liquid flow having in at least a part of the infusion chamber a flow direction which projects from the chamber wall;
(ii) moving, with the chamber wall having a liquid tight inner surface facing the infusion chamber which defines the inside of the infusion chamber and an outer surface facing away from the infusion chamber towards the exterior, the passage comprising an opening in the chamber wall between the inner surface and the outer surface, and the cartridge further comprising an outer wall covering at least a part of the outer surface, the outer wall relative to the chamber wall to cover and close the opening in the chamber wall; and
sealing off the opening, said sealing off comprising pressing the outer surface onto the outer wall upon moving the outer wall;
(iii) exerting a manual force on a manual control of the cartridge to open or close the passage, the manual control comprising a cover covering a top-side of the chamber wall and interlocking with the chamber wall, the cover comprising:
a cup-shaped grip which is partitioned in a first upwards open part for admitting at least one finger of the user and a second upwards open part for admitting at least one other finger of the user, and
a partitioning wall with sidewalls for manually exerting with the fingers a rotational force, the partitioning wall separating the upwards open parts, the partitioning wall extending radially from a peripheral edge of the grip inwards; and
deforming the edge and releasing the interlocking between the cover and the chamber wall by squeezing with the fingers on the partitioning wall.

54. (canceled)

55. (canceled)
